(19) United States
(12) Patent Application Publication
(10) Pub. No.: US 2026/0228539 A1
(43) Pub. Date: Aug. 6, 2026

(54) MACHINE LEARNING BASED PROCESSING OF NETWORK OPERATIONS USING SEQUENCE ALIGNMENT

(71) Applicant: ADP, Inc., Roseland, NJ (US)

(72) Inventors: Ewerton Oliveira, Porto Alegre (BR); Ash Tounsi, Belleville, NJ (US); Matheus Westhelle, Porto Alegre (BR); Allan Barcelos Silva, Porto Alegre (BR); Roberto Silveira, Roseland, NJ (US); Guilherme Gomes, Porto Alegre (BR); Roberto Masiero, Roseland, NJ (US); Thomas da Silva Paula, Porto Alegre (BR)

(73) Assignee: ADP, Inc., Roseland, NJ (US)

(21) Appl. No.: 19/042,674

(22) Filed: Jan. 31, 2025

(51) Int. Cl. G06N 3/09; G06N 3/0475; G06Q 40/12

(52) U.S. Cl. CPC G06N 3/09; G06N 3/0475; G06Q 40/125

(57) ABSTRACT

Machine learning based processing of network operations using sequence alignment is described to meet performance criteria. A system can identify, from a plurality of function sequences, a sequence to perform an action and identify, for the action, a constraint on an order of functions within the sequence. The system can identify a machine learning (ML) model trained on performance data related to execution of actions using sequences of functions and according to a plurality of constraints for the plurality of actions. The system can determine, using the ML model, a likelihood that the sequence of functions performs the action within a performance tolerance and according to the constraint. The system can provide, responsive to the likelihood satisfying a threshold, an instruction to the transaction processing system to cause the transaction processing system to perform the action using the sequence of functions.

### TECHNICAL FIELD

This application is generally related to computing technology, and particularly to a computing technology solution for processing network operations using machine learning.

### BACKGROUND

Data processing technologies can automate processes, provide predictive analytics, and streamline data management. However, as the data relationships and transactional processes within digital ecosystems become increasingly intricate, it can be challenging for data processing systems to effectively, efficiently, and reliably navigate such interdependencies in an accurate and consistent manner.

### SUMMARY

Aspects of the technical solutions described herein provide a machine learning (ML) based validation framework for improving the reliability of network operations in a data processing systems. Modern data processing can use various applications and ML functionalities to automate the execution of operations. However, ML-based processing can be susceptible to several technical challenges, such as machine learning malfunctions. Examples of such malfunctions include drifting or hallucinations of models in which the models can generate outputs that are inconsistent with the intended outcomes. When ML models select applications from a toolset of functions for implementing operations, hallucinations can lead to errors in function calling. Aspects of the technical solutions described herein overcome these challenges by validating the sequence of functions called by the automated processing system to verify that the correct selections of functions are called and in a correct order. Using constraints, such as boundary conditions and rules, the technical solutions described herein validate the order of functions, checking that certain functions do not execute until prerequisite steps are completed, thereby reducing potential hallucinations and increasing the overall system accuracy and energy efficiency.

The technical solutions described herein are rooted in computing technology and address technical challenges rooted in computing technology, particularly machine learning-related malfunctions, such as hallucinations. The technical solutions described herein address such technical challenges and improve the performance of the computing technology by reducing potential hallucinations and increasing the overall system accuracy. The technical solutions described herein further improve the energy efficiency of such machine learning-based systems. Further, the technical solutions described herein provide practical applications. For example, in the case of systems that use machine learning-based models that are susceptible to hallucinations and other technical challenges, the technical solutions described herein constrain the execution of the functions (i.e., one or more computer-executable instructions) based on one or more constraints to limit such technical challenges. Such constraints can be predetermined as well as dynamically selected at runtime. In some examples, constraints can limit the order of the execution of the functions. In addition, or alternatively, the constraints can limit the selection of the functions to be executed based on one or more performance criteria.

An aspect of the technical solutions can be directed to a system. The system can include one or more processors, coupled with memory. The one or more processors can be configured (e.g., via instructions or data stored in the memory) to identify, from a plurality of sequences, a sequence of functions to perform an action on a transaction processing system. The one or more processors can be configured to identify, for the action, a constraint on an order of functions within the sequence of functions. The one or more processors can be configured to identify one or more machine learning (ML) models trained on performance data related to execution of a plurality of actions using sequences of functions and according to a plurality of constraints for the plurality of actions. The one or more processors can be configured to determine, using the one or more ML models, a likelihood that the sequence of functions performs the action within a performance tolerance and according to the constraint. The one or more processors can be configured to provide, responsive to the likelihood satisfying a threshold, an instruction to the transaction processing system to cause the transaction processing system to perform the action using the sequence of functions.

The one or more processors can be configured to receive a request to perform the action and identify, responsive to the request, the functions to perform the action. The one or more processors can be configured to identify the plurality of sequences of the functions, each sequence of the plurality of sequences comprising an order in which to execute the functions that is different from an order in which to execute the functions of each other sequence of the plurality of sequences.

The one or more processors can be configured to select, from the plurality of sequences, a selection of sequences comprising the sequence. Each sequence of the selection of sequences can satisfy one or more constraints on the respective order of functions within each sequence of the selection of sequences. The one or more processors can be configured to identify, from the selection of sequences, the sequence according to the constraint and performance data of the sequence.

The one or more processors can be configured generate the plurality of sequences using a Profile Hidden Markov Model (PHMM) configured to evaluate a plurality of likelihoods for the plurality of sequences according to the constraint. The one or more ML models can include a large language model (LLM) trained on performance data related to execution of actions corresponding to at least one of: operations related to payroll processing or operations related to human resources processing.

The one or more processors can be configured to determine that one or more sequences of the plurality of sequences do not satisfy the constraint on the order of at least a subset of the functions. The one or more processors can be configured to filter out, from the plurality of sequences, the one or more sequences based on the one or more sequences not satisfying the constraint. The constraint corresponds to one or more rules configured to define an order of execution of at least a subset of the functions, the order of execution specifying that a first function of the functions be executed before execution of a second function of the functions. The constraint can correspond to one or more rules configured to preclude execution of one or more functions during the execution of the functions used to perform the action.

The one or more processors can be configured to determine, for the plurality of sequences using a multiple sequence alignment (MSA), one or more relationships between the functions. The one or more relationships can define an order in which at least a first function of the functions is to be executed before execution of a second function of the functions. The one or more processors can be configured to generate, based on the one or more relationships, a plurality of profiles for the plurality of sequences.

The performance tolerance can include a tolerance corresponding to an acceptable likelihood that the sequence of functions will be executed without an error or an interruption. The performance tolerance can include a tolerance corresponding to an acceptable variance in system performance metrics. The performance metrics can include at least one of: an execution time, an amount of resources used, a throughput of functions per unit of time or an error rate. The performance tolerance can include at least one of: a tolerance for a duration of time to perform the action, a tolerance for an amount of resources to use to perform the action, a tolerance for an allowable error rate while performing the action, a tolerance for a minimum throughput of functions to be executed within a specified period, or a tolerance for a latency between initiating performance of the action and completion of the performance of the action from the transaction processing system.

The one or more processors can be configured to utilize a directed acyclic graph (DAG) to represent dependencies between the functions according to the constraint. The one or more processors can be configured to determine, for each of the plurality of sequences, a risk score corresponding to a likelihood that the respective sequence of the plurality of sequences results in an error during the performance of the action. The one or more processors can be configured to select, from the plurality of sequences, the sequence of functions based on the respective score of the sequence of actions. The one or more processors can be configured to determine, responsive to the likelihood not satisfying the threshold, to not transmit the instruction to the transaction processing system.

The one or more processors can be configured to train the one or more ML models using labeled datasets comprising sequences of functions performing the plurality of actions in a correct order and sequences of functions performing the plurality of actions in an incorrect order. The one or more processors can be configured to utilize, following the training, the one or more ML models to identify one or more patterns for the plurality of sequences. The one or more processors can be configured to classify, based on the one or more patterns, the one or more sequences to select the sequence of functions.

An aspect of the technical solutions is directed to a method. The method can include identifying, by one or more processors coupled with memory, from a plurality of sequences, a sequence of functions to perform an action on a transaction processing system. The method can include identifying, by the one or more processors, for the action, a constraint on an order of functions within the sequence of functions. The method can include identifying, by the one or more processors, one or more machine learning (ML) models trained on performance data related to execution of a plurality of actions using sequences of functions and according to a plurality of constraints for the plurality of actions. The method can include determining, by the one or more processors, using the one or more ML models, a likelihood that the sequence of functions performs the action within a performance tolerance and according to the constraint. The method can include providing, by the one or more processors, responsive to the likelihood satisfying a threshold, an instruction to the transaction processing system to cause the transaction processing system to perform the action using the sequence of functions.

The method can include receiving, by the one or more processors, a request to perform the action. The method can include identifying, by the one or more processors, responsive to the request, the functions to perform the action. The method can include identifying, by the one or more processors, the plurality of sequences of the functions, each sequence of the plurality of sequences comprising an order in which to execute the functions that is different from an order in which to execute the functions of each other sequence of the plurality of sequences.

The method can include selecting, by the one or more processors, from the plurality of sequences, a selection of sequences comprising the sequence. Each sequence of the selection of sequences can satisfy one or more constraints on the respective order of functions within each sequence of the selection of sequences. The method can include identifying, by the one or more processors, from the selection of sequences, the sequence according to the constraint and performance data of the sequence.

The method can include determining, by the one or more processors, that one or more sequences of the plurality of sequences do not satisfy the constraint on the order of at least a subset of the functions. The method can include filtering out, by the one or more processors, from the plurality of sequences, the one or more sequences based on the one or more sequences not satisfying the constraint.

An aspect of the technical solutions is directed to a non-transitory computer-readable media having processor readable instructions. The instructions, when executed, can cause at least one processor to identify, from a plurality of sequences, a sequence of functions to perform an action on a transaction processing system. The instructions, when executed, can cause at least one processor to identify, for the action, a constraint on an order of functions within the sequence of functions. The instructions, when executed, can cause at least one processor to identify one or more machine learning (ML) models trained on performance data related to execution of a plurality of actions using sequences of functions and according to a plurality of constraints for the plurality of actions. The instructions, when executed, can cause at least one processor to determine, using the one or more ML models, a likelihood that the sequence of functions performs the action within a performance tolerance and according to the constraint. The instructions, when executed, can cause at least one processor to provide, responsive to the likelihood satisfying a threshold, an instruction to the transaction processing system to cause the transaction processing system to perform the action using the sequence of functions.

### BRIEF DESCRIPTION OF THE DRAWINGS

Aspects of the technical solutions are described in the detailed description which follows, in reference to the noted plurality of drawings by way of non-limiting examples of exemplary embodiments of the technical solutions described herein.

FIG. 1 depicts an example of a system for machine learning (ML) based validation of processing operations.

FIG. 2 depicts an architecture of a computing system implemented in embodiments of the technical solutions described herein.

FIG. 3 depicts a cloud computing environment 300 in accordance with aspects of the technical solutions described herein.

FIG. 4 depicts an example diagram of function sequences presented using a directed graph.

FIG. 5 depicts an example profile implemented for a group of function sequences.

FIG. 6 depicts example of a multiple sequence alignment (MSA) with mutations in the process.

FIG. 7 depicts an example diagram of a profile hidden Markov model (PHHM) used for probabilistic sequence alignment.

FIG. 8 depicts a flow diagram of a method for ML-based validation of processing operations using probabilistic sequence alignment.

### DETAILED DESCRIPTION

Following below are more detailed descriptions of various concepts related to, and implementations of, methods, apparatuses, and systems for machine learning based validation of processing operations using probabilistic sequence alignment. The various concepts introduced above and discussed in greater detail below can be implemented in any of numerous ways.

Modern data processing solutions can integrate various systems, tools and machine learning (ML) functionalities to automate the execution of human resources (HR) or payroll operations. Such automated operations implemented using ML models can be susceptible to various ML malfunctions, such a drifting or hallucinations in which the model can generate solutions that are inconsistent with the intended solution. In systems in which large language models (LLMs) select, from a toolset of different applications or functions, specific applications or functions for performing certain operations or transactions, the ML models can experience hallucinations leading to errors with respect to the function calling. For instance, an LLM for selecting calling functions to implement an operation can call an incorrect sequence of functions, resulting in an erroneous output. Such errors can lead to inefficient use of the computational resources, adversely affecting the energy efficiency of the system.

The technical solutions of the present disclosure overcome these challenges by providing an ML based validation of process operations using a probabilistic sequence alignment. The technical solutions can generate and evaluate different sequences of function calls to verify that they adhere to a logical order to achieve a successful execution. By leveraging ML models, such as LLMs, the solution can filter out incorrect sequences, thereby reducing or eliminating the potential hallucinations and enhancing the system accuracy. The system can also incorporate constraints, such as boundary conditions and rules, to control the order of the operations, barring certain actions until prerequisite steps are completed. The technical solutions can also establish thresholds for identifying dangerous sequences based on probabilistic assessments, checking that actions with low likelihoods of success are flagged for review. This comprehensive approach may improve operational reliability and optimize resource utilization and energy efficiency within the automated processing framework.

For example, the technical solutions can provide a configuration of LLMs designed to generate an ordered sequence of functions used to perform specific actions, such as performing operations to issue and provide a payment, such as an employee wage paycheck. The correct performance of the actions can include a logical progression to be followed, such as the payee and determining the amount for the payment before entering the name of the payee and the amount into the transaction or the paycheck. To validate that the process adheres to this logical flow of actions, the technical solution can run an LLM to generate a comprehensive set of possible sequences for a given set of functions. While some sequences may conform to the required logical order and be acceptable, other sequences may be out of order and therefore incorrect and leading to inaccurate results, rendering them unacceptable to the system. The technical solutions can be configured to utilize LLMs to verify that the sequence of functions adhere to acceptable standards (e.g., performance tolerances), allowing the technical solutions to filter out the instances in which the sequence is incorrect, thereby reducing or eliminating hallucinations or errors.

The technical solution can utilize constraints, such as boundary conditions, to guide the sequence toward high-likelihood outputs. The solutions can incorporate rules governing the sequences of functions, and mandating that certain actions occur before others, thereby creating an order of the functions to be executed. For instance, the technical solutions can utilize the constraints to validate that the system does not send a paycheck without first determining the pay amount. The technical solutions can define thresholds for identifying dangerous sequences based on probabilistic assessments, flagging for review those actions that have a likelihood of success that is less than a threshold likelihood (e.g., likelihood of less than 90%, 70%, 50%, 30%, 15% or 5%, depending on the implementation). Such a probabilistic analysis can facilitate that only sequences with a sufficiently high probability of success are executed.

The technical solution can integrate a loss function that adjusts configurations to minimize changes in output sequences, maintaining operational reliability over time. The technical solutions can utilize various agents, such as chatbot agents, to facilitate specific sequences or configurations, improving user interaction with the system and the operational efficiency. By leveraging techniques, such as Profile Hidden Markov Models (PHHM), the system can generate sequences and evaluate their performance against established rules. This capability can allow for real-time detection and prevention of hallucinated sequences in which the LLM can invent hallucinated data, such as function IDs or tokens. By uploading rules for particular actions, the LLM can execute a band of rules to determine a plurality of sequences according to those rules and assess their probabilistic values. Dangerous or unacceptable functions can then be filtered out based on their low probabilities.

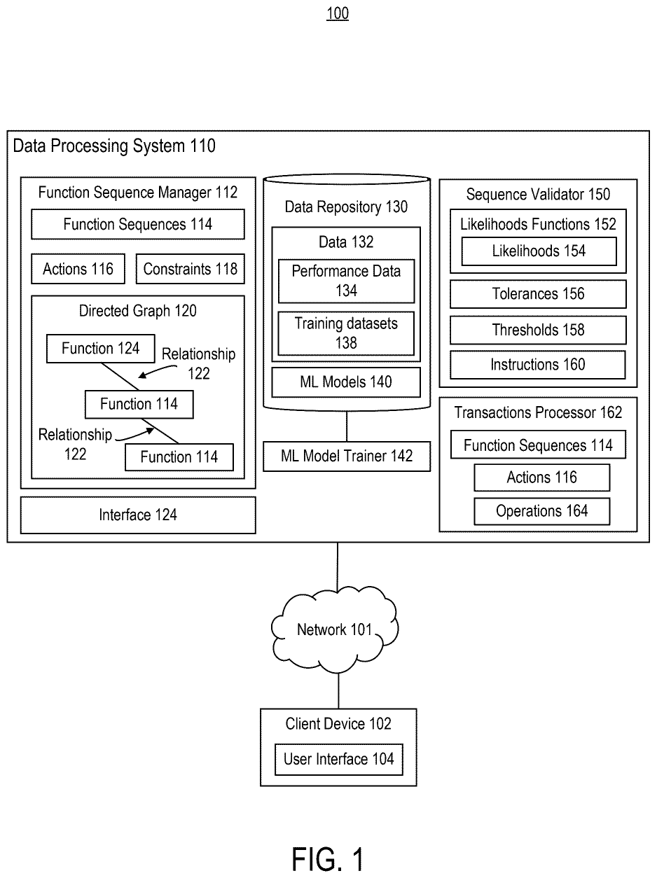

FIG. 1 depicts an example system 100 for providing a machine learning based validation of processing operations using probabilistic analysis, such as a probabilistic sequence alignment. The system 100 can include one or more client devices 102 communicating with a data processing system 110 via a network 101. The client device 102 can provide a user interface 104 allowing a user to instruct a data processing system 110 to implement automated processing of various system operations. Data processing system 110 can include one or more of: function sequence managers 112, Interfaces 126, data repositories 130, ML model trainers 142, sequence validators 150 and transactions processors 160. A function sequence manager 112 can include one or more function sequences 114 for performing actions 116 according to constraints 118. The function sequence manager 112 can include one or more directed graphs 120 that can present or indicate an order or sequence of functions 124 according to their relative relationships 122. A data repository 130 can store ML models 140 trained to performance data 134 and training data sets 138 that can be stored as data 132 in the data repository 130. A sequence validator 150 can include one or more likelihood functions 152 for determining likelihoods 154 for various function sequences 114, according to tolerances 156 and thresholds 158. The sequence validator 150 can utilize the likelihoods 154 for different functions 124, based on the related relationships 122, tolerances 156 and thresholds 158, to select and align the functions 124 into a function sequence 114 with a sufficient (e.g., above a predetermined threshold) or the greatest (e.g., maximized) likelihood of successful implementation of the given action 116 out of all other options (e.g., likelihoods of other function sequences). The sequence validator 150 can generate or provide instructions 160 for the transaction processor 162, which can utilize the selected function sequence 114 to perform actions 116 according to operations 164 and based on the instructions 160.

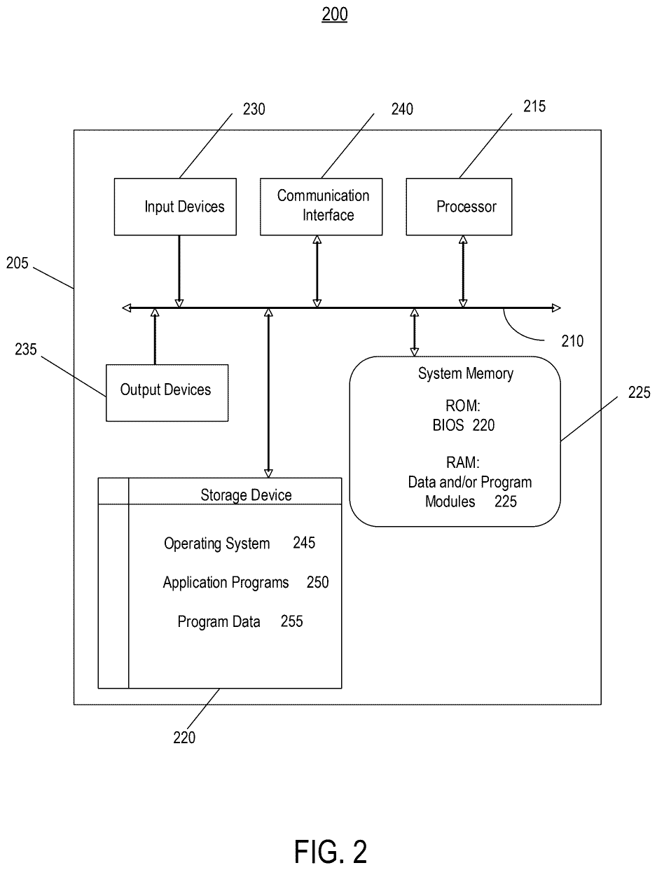

The data processing system 110 can include any combination of hardware and software for providing a machine learning based validation of processing operations using probabilistic sequence alignment. Data processing system 110 can include a computing device or a system, such as a computing system 200 of FIG. 2. Data processing system 110 can include, or be provided via, one or more physical or virtual servers or machines, cloud-based system (e.g., a software as a service) or any collection of one or more (e.g., a network of) physical or virtual computing devices. The data processing system 110 can be coupled, via a network 101, with any number of client devices 102 that can send to the data processing system different requests or instructions to process, compute, determine or implement various operations 164 based on instructions 160 generated by the sequence validator 150 to execute function sequences 114 according to constraints 118 and relationships 122 between the individual functions 124 to complete actions 116 in a correct order or sequence to accurately perform the operations 164.

The data processing system 110 can include, or be communicatively coupled with (e.g., via a network 101), at least one logic device such as one or more client devices 102. Data processing system 110 can be implemented on one or more processors (e.g., 215) based on instructions, data or commands stored on system memory (e.g., 225) or a storage device (e.g., 220), which can be used to operate or cause the one or more processors to implement the functionalities of the data processing system 110. In some configurations, functions, such as transactions processors 162 can be deployed on separate computing systems (e.g., such as computing system 200 of FIG. 2), which can be deployed on a server, a virtual machine or a cloud computing platform and coupled with the data processing system 110 via a network 101.

The network 101 can be a wireless or wired connection for enabling the data processing system 110 to store, transmit, receive, or display information to identify, extract, and map a data set from a first type to a second type. The data processing system 110 can communicate with internal subcomponents (described herein), or external components (e.g., the transactions processors 162 or the client device 102, among others) via the network 101. The data processing system 110 can, for example, store data about the system in the data repository 130. The data processing system 110 can, for example, receive the data set (e.g., data 132) transmitted from the data repository 130. The network can include a hardwired connection (e.g., copper wire or fiber optics) or a wireless connection (e.g., wide area network (WAN), controller area network (CAN), local area network (LAN), or personal area network (PAN)). For example, the network 101 can include Wi-Fi, Bluetooth, BLE, or other communication protocols for transferring over networks as described herein.

The client device 102 can include any computing device that can be used by a client, individual or a user requesting to implement particular operations 164, such as any automated data processing operation, such as operations 164 corresponding to inventory management, customer relationships, supply chain, sales forecasting, marketing automation, quality control, risk management and compliance monitoring. The client device 102 can be used by a user for triggering execution of various operations 164. The client device 102 can be or can include any computing device such as a laptop, a desktop computer, a smart phone or a tablet. A user of the client device 102 can operate, display, or otherwise execute an application (e.g., a web browser or one or more agents for using a data processing system 110) via the client device 102. The client device 102 can include, or be coupled with, storage or memory (e.g., 225).

The client device 102 can include a user interface 104, such as a window or a prompt of an application executed on a client device 102 to communicate with and utilize features of the data processing system 110. The user interface 104 can provide a user with one or more windows to request access to transactions processors 162 to implement various operations 164. The client device 102 can allow a user to utilize a user interface 104 to access any functionality of a data processing system 110, including data repository 130 or transactions processors 162. A user interface 104 can be a graphical user interface (GUI) allowing a user to request or initiate operations 164 (e.g., operations for payroll processing, annual tax computation, computation of wages, payment processing or similar).

The user interface 104 can be configured to provide access to functionalities of the data processing system 110, such as operations 164 to be executed by the transactions processor 162 via function sequences 114. For instance, an application for providing interaction between a client device 102 and a data processing system 110 can provide or generate a user interface 104 for interacting with operations 164 to be executed using function sequences 114 defined via a directed graph 120. The client device 102 or its user can receive, via the user interface 104, a window displayed on a display of the client device 102 showing options for the user of the client device 102 to select or manipulate. The user interface 104 can receive selections, prompts or entries via elements of the user interface 104 (e.g., mouse selections or commands entered) to instruct or trigger execution of operations 164.

Function sequences 114 can include any order or sequence of functions 124 for implementing actions 116. Function sequence 114 can include an order, list or a chain of functions 124, such as steps, computations or operations 164 to be implemented in order to achieve a particular action 116. Function sequence 114 can define how a specific action 116 is to be performed by the data processing system 110, including sequence and order of operations 164, any inputs and outputs to be provided from some operation to the next, any constraints 118 to be applied. The function sequences 114 can be chained or ordered based on relationships 122 between individual functions 124 of the function sequence 114. For instance, actions 116 can be performed using function sequences 114 that can include instructions for executing tasks such as calculating payroll or processing customer orders. For example, function sequences 114 can outline the steps for validating a transaction, including checking account balances and confirming transaction details before finalizing the operation 164 that can rely on such a validation.

Action 116 can include any action to be implemented by one or more functions 124 that can be implemented by one or more operations 164 of a transactions processor 162. An action 116 can include any one or more tasks or operations 164 that the data processing system 110 can perform as part of its automated processing. An action 116 can include activities of an automated data processing system 110, such as issuing payments, transacting assets (e.g., monetary or other resources) to client or user accounts, generating reports, or updating inventory levels. For instance, an action 116 can include sending an invoice to a customer after validating an order through the appropriate function sequence 114.

Constraint 118 can include any limitation or a constraint on an order or sequence of functions (e.g., function sequence 114) to be implemented. Constraint 118 can include one or more rules or conditions that can control, define or govern how one or more functions 124 are executed within data processing system 110. Constraint 118 can include limitations that ensure certain actions 116, operations 164 or functions 124 are to be completed before other actions 116, operations 164 or functions 124. For instance, constraint 118 can require that a first function 124 is to be completed before a second function 124 is to be initiated. For example, constraint 118 can specify that payment cannot be processed until all approvals for the payment have been obtained and verified, or until a final payment amount is to be determined or verified.

The constraint 118 can include or correspond to one or more rules. The rules can be configured to define a sequence or an order of execution of a set or subset of functions 124. For instance, a constraint 118 can include a rule identifying or specifying which functions 124 (e.g., corresponding to one or more operations 164 for implementing an action 116) should be executed before other functions 124 of the function sequence 114. For instance, one or more rules of one or more constraints 118 can specify that a first function 124 of a function sequence 114 be executed before execution of a second function 124 of the same function sequence 114. For instance, the constraint 118 can correspond to one or more rules configured to preclude execution of one or more functions 124 during a particular function sequence 114, or during the execution of the functions 124 used to perform a particular intended action 116.

Directed graph 120 can include any structured representation of relationships 122 between various functions 124 that can be completed for a particular one or more actions 116 or operations 164. Directed graph 120 can include a directed acyclic graph (DAG) or a knowledge graph, which can be structured to indicate various entities or components (e.g., functions 124, actions 116 or operations 164) which can be related to each other via relationships 122 (e.g., dependencies or defined order in a sequence). Directed graph 120 can include or define dependencies between various functions 124, actions 116 or operations 164, indicating which of the functions 124, actions 116 or operations 164 are to be completed or implemented prior to implementing other functions 124, actions or operations 164. Directed graph 120 can indicate or define how different function sequences 114, actions 116 or operations 164 are interconnected with each other, what are their respective percentages or likelihoods, thereby indicating the most likely order of operations or functions for a given task (e.g., action 116). For example, a directed graph 120 can depict a flow in which a first function 124 can be completed before a second function 124 can begin or be completed, thereby ensuring a proper sequencing.

Function 124 can include any combination of hardware and software for implementing a given task or a step for completing an action 116. Function 114 can include computer code, instructions or data for implementing one or more operations 164 in a particular order or sequence in order to achieve or execute an action 116. Function 124 can include a computer code in any particular language, such as C, C++, JSON or Python. Function 124 can include any executable unit of work or action to be taken for a given action 116, such as determining an amount of taxes to pay, determining a paycheck amount to apply to a client account, or validating customer information. For instance, function 124 can include retrieving user data from a database to facilitate further processing, applying retrieved data to a particular computational setup (e.g., an operational function) or executing such a computational setup to determine an amount for an output.

Relationship 122 can describe the connections and dependencies between different functions 124. A relationship 122 can indicate how one function 124 influences or is dependent on another function's execution. A relationship 122 can include a value corresponding to a likelihood (e.g., between 0 and 1, or between 0% and 100%) indicating a value (e.g., percentage) corresponding to the likelihood that a second function 124 follows a first function 124 for a given action 116 or operation 164 Relationship 122 can include or define dependencies between different functions 124, such as outputs from a first function 124 to be inserted into a second function 124. For example, a relationship 122 can establish, state or indicate that given function 124 cannot start until both a first function 124 and a second function 124 have been successfully completed.

Function sequence manager 112 can include any combination of hardware and software designed to manage the function sequences 114 that can be used to execute specific actions 116 of operations 164. The function sequence manager 112 can include instructions, computer code, or data configured to implement or execute a series of function calls based on a predefined criteria. For example, the function sequence manager 112 can utilize a directed graph 120 to establish, determine or evaluate various function sequences 114 based on individual functions 124 to generate or implement particular actions 116 based on relationships 122 (e.g., likelihoods of interdependencies or correlations) between the individual functions 124. The functions sequence manager 112 can determine relationships 122 in terms of likelihoods that one function 124 precedes another function 124 in order to establish the most likely function sequence 114 for a given action 116 based on the constraints 118. For instance, the function sequence manager 112 can utilize the directed graph 120 to determine the function sequence 114 (e.g., series of functions 124 and their most likely order or sequence based on their relationships 122) in order to process a paycheck, such that each function 124 is executed in a logical order within particular tolerances 156 for given likelihoods 154 and thresholds 158 for each given one or more functions 124.

Function sequence manager 112 can identify, from a plurality of function sequences 114, a particular function sequence 114 to be used to perform an action 116 on a transaction processing system (e.g., transaction processor 162). The function sequence manager 112 can identify, for an action 116, a constraint 118 on an order of functions 124 within a given function sequence 114. The function sequence manager 112 can identify one or more ML models 140 trained on performance data 134 that can be related to execution of a plurality of actions 116 using function sequences 114 and according to a plurality of constraints 118 for the plurality of actions 116. The function sequence manager 112 or the sequence validator 150 can utilize the one or more ML models to identify all the function sequences 114 for the given action.

In an example, the function sequence manager 112 can receive a request from a client device 102 to perform a given action 116. For instance, a user of a client device 102 can utilize the user interface 104 to specify, identify, trigger or prompt a given action 116. The function sequence manager 112 can intercept the request and identify, responsive to the request, the functions 124 to perform the action. For instance, the function sequence manager 112 or the sequence validator can identify a function sequence 114 based on the directed graph 120, such as by identifying the relationships 122 between the functions 124 that correspond to highest likelihoods 154. The function sequence manager 112 can identify the plurality of function sequences 114, such that sequence of the plurality of sequences include an order in which to execute the functions 124. Each function sequence 114 can include an order of functions 124 that is different from an order in which to execute the functions 124 of each other sequence of the plurality of function sequences 114. The sequence validator 150 can test and evaluate these function sequences 114 generated by the function sequence manager 112 and identify the function sequence 114 to use for the implementation of action 116. The function sequence manager 112 can generate the plurality of sequences using a Profile Hidden Markov Model (PHMM) configured to evaluate a plurality of likelihoods 154 for the plurality of sequences according to the constraint 118.

The function sequence manager 112 can determine, for the plurality of function sequences 114 using a multiple sequence alignment (MSA), one or more relationships 122 between the functions 124. The one or more relationships 122 between the functions 124 (e.g., within a DAG) can define an order in which at least a first function 124 of the function sequence 114 is to be executed before execution of a second function 124 of the functions 124. For instance, the function sequence manager 112 can utilize the likelihoods 154 corresponding to relationships 122 between different functions 124 in a function sequence 114 to select functions 124 that are aligned or ordered (e.g., in a chronological order of their execution) to maximize the likelihood of a successful execution of the operations 164 to implement the action 116 without errors or failure. The function sequence manager 112 can generate, based on the one or more relationships 122, a plurality of profiles for the plurality of function sequences 114. A profile of a function sequence 114 can identify the constraints 118, tolerances 156 and thresholds 158 associated with the given functions sequence 114, which the sequence validator 150 can utilize to identify, select or validate the function sequence 114 to use for processing the action 116 via the transactions processor 162.

Interface 126 can include any combination of hardware and software for facilitating interaction between a data processing system 110 and client devices 102. Interface 126 can include any type and form of an interface designed for client device interaction, control and use of a data processing system 110. An Interface 126 can provide a graphical or textual elements that can work with user interface 104 of a client device 102 allowing users to input data, request operations, and receive feedback from the data processing system 110. For instance, Interface 126 can include feature buttons for initiating specific actions or displaying results from processed transactions.

Data repository 130 can include any combination of hardware and software for providing data storage. Data repository 130 can store any type and form of data, including performance data 134, training datasets 138, likelihoods 154, tolerances 156, thresholds 158, instructions 160, directed graph 120 or any data on its functions 124 or relationships 122. Data repository 130 can include or provide a structured storage solution, such as databases or data structures for managing various types of data utilized by the data processing system 110. Data repository 130 can store information such as user or client profiles that can include various client data (e.g., rates for hourly wages, number of hours worked per pay period, account numbers for client transactions, transaction records, or historical data or metrics). For example, data repository 130 can include records of all completed transactions for auditing purposes.

The data repository 130 can provide storage via any type or kind of memory, such as a cloud or hard drive. The data repository 130 can include or utilize, for example, random access memory (RAM), dynamic random-access memory (DRAM), static random-access memory (SRAM), error correcting code (ECC), read only memory (ROM), programmable read only memory (PROM), or electrically erasable read only memory (EEPROM). The information or data structures (e.g., tables, lists, or spreadsheets) contained within the data repository 130 can be dynamic and change periodically (e.g., daily or every millisecond), via information from the server (e.g., through batch processing, real-time streaming, webhooks, scheduled jobs, incremental updates, database triggers, API requests, or version control systems, among others), via an input from a user (e.g., a user operating the client device 102), via information from the data repository 130, or the client device 102, transmitted through the network 101, via inputs from subcomponents of the data processing system 110 or via an external update to the system 100. For example, the ML models 140 within the data repository 130 can change or be updated responsive to an indication, instruction or data from the model trainer 142 or new processes or outputs from any transactions processors 162 that can update any data 132 within the data repository 130.

Data 132 can include any type and form of data or information stored within the data repository 130. Data 132 can include information that can be used by the data processing system 110 to implement various operations 164. Data 132 can include any one or more of: performance data 134, training datasets 138, likelihoods 154, tolerances 156, thresholds 158, instructions 160 or directed graphs 120 and its information or components (e.g., functions 124 or relationships 122). Data 132 can include, for example, metadata for various content or resources, resource retrieval locations, batching queries, access control lists, content descriptions. Data 132 can include for inputs or implementations of functions 124 or operations 164. For instance, data 132 can include customer details needed for processing orders or inventory levels required for stock management.

Thresholds 158 can include any value or limitation used to determine when an action is outside of an acceptable range of tolerance 156. Thresholds 158 can include or correspond to specific criteria used by the sequence validator 150 to determine when an action should be flagged for review due to potential issues in execution. A threshold 158 can be a threshold amount for a likelihood 154. For instance, a threshold 158 can be a threshold for a likelihood 154 of a function sequence 114, such that when the likelihood 154 satisfies the threshold 158, the sequence validator 150 can determine that the function sequence 114 is valid and is to be used by the transactions processor 162 to perform an operation 164. Thresholds 158 can help identify function sequences 114 that may pose risks based on their likelihoods 154 or performance data 134 corresponding to performance metrics falling outside of their corresponding thresholds 158. For example, a threshold 158 can be a threshold for a performance data 134 identifying a limit beyond which a performance data 134 satisfies or exceeds a threshold performance, or falls short of the minimum acceptable performance, depending on the design. For example, a threshold 158. for example, threshold 158 could indicate that any function sequence with less than a specified probability of success should be rejected or accepted, based on the threshold 158.

Performance data 134 can include metrics and statistics related to functions 124 or operations 164. Performance data 134 can include metrics and statistics indicative of a rate of success or how well various functions 124 and operations 164 perform within the data processing system 110. Performance data 134 can include data to be compared with tolerances 156 for various operations or functions 124. Performance data 134 can provide insights into efficiency and effectiveness by tracking key performance indicators. For example, performance data 134 can indicate an average processing times for transactions or error rates during function execution.

Performance data 134 can include performance tolerance 156 that can include a tolerance value or a range corresponding to an acceptable variance in system performance metrics. The performance metrics can include, for example, an execution time, an amount of resources used, a throughput of functions per unit of time or an error rate for a particular action 116, operation 164 or function 124. Performance data can include a performance tolerance 156, such as a tolerance 156 for a duration of time to perform the action, a tolerance 156 for an amount of resources to use to perform the action, a tolerance 156 for an allowable error rate while performing the action, a tolerance 156 for a minimum throughput of functions to be executed within a specified period, or a tolerance 156 for a latency between initiating performance of the action and completion of the performance of the action from the transaction processing system (e.g., transactions processor 162).

Tolerance 156 can include any information, such as values or parameters identifying, defining or corresponding to limits regarding variations in performance outcomes that are acceptable or result in successful performance. Tolerances 156 can include values or parameters associated with executing function sequences 114, including acceptable ranges of likelihoods 154 corresponding to, or defining, relationships 122 between different functions 124. For instance, a sequence validator 150 can utilize tolerances 156 to determine if the likelihood 154 corresponding to, or defining, a relationship 122 between two or more functions 124 are satisfied, in order to implement that function sequence 114 or reject it in favor of a different function sequence 114. Tolerance 156 can include values for comparing with thresholds 158 beyond which performance or outcomes are considered unacceptable or outside of the range of tolerances 156. For instance, tolerance 156 can specify that transaction processing times should not exceed a certain duration without triggering alerts.

The tolerances 156 can include tolerances on performance (e.g., the performance tolerances), which can include a tolerance corresponding to an acceptable likelihood 154 that a given function sequence 114 will be executed by the transactions processor 162 without an error or an interruption. The tolerance 156 includes a tolerance on performance that can correspond to an acceptable variance in system performance metrics. The performance metrics of the system can include, for example, metrics on duration of an execution time, an amount of resources used for execution, a throughput of functions 124 per unit of time or an error rate for an execution of a function sequence 114. The performance tolerance 156 can include any one or more of: a tolerance for a duration of time to perform the action 116 or function sequence 114, a tolerance for an amount of resources to use to perform the action 116 or a function sequence 114, a tolerance for an allowable error rate while performing the action 116 or a function sequence 114, a tolerance for a minimum throughput of functions 124 to be executed within a specified period for a given function sequence 114, or a tolerance for a latency between initiating performance of the action 116 or a function sequence 114 and completion of the performance of the action 116 or the function sequence 114 by the transaction processor 162.

Sequence validator 150 can include any combination of hardware and software for validating operation or performance of function sequences 114. Sequence validator 150 can include any functionality for validating likelihoods 154 for various relationships 122 between functions 124, in view of performance tolerances 156 and thresholds 158. Sequence validator 150 can include the functionality for validating components responsible for assessing whether function sequences 114 adhere to established rules and logical orders before execution. Sequence validator 150 can evaluate sequences based on defined criteria such as likelihoods and constraints to ensure correctness in operations, for example, sequence validator 150 may check if all prerequisite functions have been completed before allowing subsequent actions to proceed. Sequence validator 150 can include the functionality for generating instructions 160 to the transactions processor 162 to perform one or more actions 116 using validated function sequences 114 (e.g., function sequences 114 whose likelihoods 154 given tolerances 156 satisfied the thresholds 158).

Sequence validator 150 can include the functionality to determine, using the one or more ML models 140, a likelihood 154 that the function sequence 114 performs the action within a performance tolerance and according to the constraint 118. The sequence validator 150 can provide, responsive to the likelihood 154 satisfying a threshold 158, an instruction 160 to the transactions processor 162 to cause the transactions processor 162 to perform the action 116 using the function sequences 114. Using the likelihoods 154 corresponding to relationships 122 between different functions 124 in a function sequence 114, the sequence validator 150 can validate or verify that the selected functions 124 are aligned to maximize the likelihood of a successful execution of the operations 164 to implement the action 116 without errors or failure. The sequence validator 150 can select, from the function sequences 114, a function sequence 114 to be implemented by the transactions processor 162. Each sequence of the selection of function sequences 114 can satisfy one or more constraints 118 on the respective order of functions within each sequence of the selection of function sequences 114. The subset of the function sequences 114 satisfying the same one or more constraints 118 can be evaluated by the sequence validator 150 on the performance likelihoods 154 given the tolerances 156 (e.g., performance tolerance ranges) in comparison to their respective thresholds.

For instance, the sequence validator 150 can identify, from the selection of function sequences 114, the sequence according to the constraint 118 and performance data of the function sequence 114. The sequence validator 150 can determine that one or more function sequence 114 of the plurality of function sequence 114 that do not satisfy the constraint 118 on the order of at least a subset of the functions. The sequence validator 150 can filter out, from the plurality of function sequences 114 being considered for execution, the one or more sequences 114 based on the one or more function sequence 114 not satisfying the constraint 118. The sequence validator 150 can determine, for each of the plurality of sequences, a risk score corresponding to a likelihood that the respective function sequence 114 of the plurality of function sequence 114 results in an error during the performance of the action. The risk score can be used to determine or select the function sequence 114 to be used or sent with the instruction 160 for execution by the transactions processor 162. The sequence validator can select, from the plurality of sequences, the function sequence 114 based on the respective score of the sequence of actions 116 or operations 164. The sequence validator 150 can determine, responsive to the likelihood 154 not satisfying the threshold 158, to not transmit the instruction to the transactions processor 162.

Likelihood functions 152 can include any combination of hardware and software for determining or representing likelihoods 154 for given relationships 122 between functions 124. Likelihood functions 152 can include any representations used by the sequence validator 150 to determine the likelihood 154 or probability of success associated with various function sequences 114. Likelihood functions 152 can analyze historical performance data to assess how likely it is that a given function sequence 114 (e.g., given its series of functions 124 and their relationships 122) will achieve its intended outcome. For instance, likelihood function 152 can calculate a likelihood 154 that a first function 124 is to be performed before a second function 124 is to be performed. The likelihood function 152 can make such a determination for any combination of any of the likelihoods 154 for any relationships 122 between any functions. The likelihood function 152 can operate with the sequence validator 150 to identify the function sequence 114 that has the highest likelihood 154 or likelihoods 154 to achieve the accurate or reliable result, based on past transaction success rates (e.g., using one or more ML models 140).

Likelihoods 154 can represent specific probability values assigned to different outcomes associated with executing function sequences 114 within the system. Likelihoods 154 can correspond to, or define, various relationships 122 between any arrangement, order or selection of functions 124. Likelihoods 154 can be implemented for a variety of likelihoods 154 to provide quantitative measures for assessing which function sequences 114 are more likely to succeed based on historical performance metrics.

Instruction 160 can include any command or a directive generated by a sequence validator 150 in response to a validation of a function sequence 114. Instruction 160 can include an instruction or a command to implement a particular one or more operations according to a particular function sequence 114 that was validated by the sequence validator 150. Instruction 160 can include commands or directives generated by components within the system to guide actions taken by the transaction processor 162. Instructions 160 can include or reference a function sequence 114 which the transactions processor 162 can utilize to implement the operations 164 according to the given function sequence 114 and implement the action 116. Instruction 160 can include the guidance on how operations should be executed based on validated function sequence 114 satisfying the thresholds 158 and tolerances 156 for the given constraints 118.

Transactions processor 162 can include any combination of hardware and software for implementing actions 116. Transactions processor 162 can implement an action 116 according to a validated function sequence 114, in response to instruction 160 from the sequence validator 150. Transactions processor 162 can include components responsible for executing specific functions 124, operations 164 based on the validated function sequence 114 referenced by the instruction 160. Transactions processor 162 can carry out tasks, such as implementation of any actions 116 or operations 164, including for example, processing payments, accessing or updating client accounts, transferring funds, updating records, paying or satisfying tax requirements or any other functionality discussed herein or corresponding to payroll or HR operations or processes.

For instance, transactions processors 162 can include any combination of hardware and software, including software applications or functions, for implementing any system operations or transactions for any action 116. For example, a transactions processor 162 can implement operations for computation of balances or amounts involving pay stubs, employee salaries, bonuses, or medical or other benefits, including medical leaves, employee vacations or personal time off days. Transactions processor 162 can implement computations or transactions involving sickness entitlement, annual leave (e.g., annual leave balances), payment plans for parental leaves, forfeit of adjustments and balances, buying and selling of leave balances, public holiday adjustments and balances, timesheet to balances, overtime computations, or any other time-related or compensation related transactions or computations. Transactions processor 162 can include transactions for processing federal or state taxes, employee income taxes, monthly tax deductions, enterprise tax payments or any other tax related amounts for any geographical area, depending on the user accounts or metadata associated with the account (e.g., employee's citizenship or residence). Transactions processors 162 can include functions for processing time entries, employee clock (e.g., start and stop work time), employee facility access card activity monitoring functions or any other functions associated with behavior or actions of users (e.g., employees) associated with user accounts.

Machine learning (ML) model 140 can include any type and form of a computational framework designed (e.g., trained) to analyze data and make predictions based on learned patterns from training datasets 138. ML model 140 can be utilized for various purposes within the data processing system 110, such as determining likelihoods 154 that a function sequence 114 performs actions 116 within a performance tolerance 156. For example, ML model 140 could predict the likelihood that a given function sequence 114 is going to provide an accurate result within a particular constraint 118 (e.g., a set threshold amount of processing resources, computational power or energy utilized). ML models 140 can include a large language model (LLM) trained on performance data 134 related to execution of actions 116 corresponding to at least one of: operations related to payroll processing or operations related to human resources processing.

Machine learning model (140), which can also be referred to as models 140, LLMs 140 or generative AI models 140, can include any computational framework that utilizes algorithms to learn patterns from data to make predictions or decisions based on new, unseen information without being explicitly programmed for each specific task. ML model 140 can be used for various tasks of the data processing system 110, such as generating directed graphs 120, executing operations 164, determining or evaluating function sequences 114, validating performance of function sequences 114 using likelihoods, tolerances 156 or thresholds. ML models 140 can be used for processing or operations such as automating document classification, optimizing tax calculations, personalizing employee benefits recommendations, analyzing compliance risks or forecasting payroll expenses.

The ML models 140 can include any combination of one or more neural networks, decision-making models, linear regression models, natural language models, random forests, classification models, generative AI models, reinforcement learning models, clustering models, neighbor models, decision trees, probabilistic models, classifier models, or other such models. For example, the models 140 include natural language processing (e.g., support vector machine (SVM), Bag of Words, Counter Vector, Word2Vec, k-nearest neighbors (KNN) classification, long short erm memory (LSTM)), object detection and image identification models (e.g., mask region-based convolutional neural network (R-CNN), CNN, single shot detector (SSD), deep learning CNN with Modified National Institute of Standards and Technology (MNIST), RNN based long short term memory (LSTM), Hidden Markov Models, You Only Look Once (YOLO), LayoutLM) (classification ad clustering models (e.g., random forest, XGBBoost, k-means clustering, DBScan, isolation forests, segmented regression, sum of subsets 0/1 Knapsack, Backtracking, Time series, transferable contextual bandit) or other models such as named entity recognition, term frequency-inverse document frequency (TF-IDF), stochastic gradient descent, Naïve Bayes Classifier, cosine similarity, multi-layer perceptron, sentence transformer, data parser, conditional random field model, Bidirectional Encoder Representations from Transformers (BERT), among others.

The ML models 140 can include generative AI models, which can include any machine learning systems configured to create new content, such as text, images, or audio, by learning patterns from the data 132 (e.g., training datasets 138). The generative AI models 140 can be trained using techniques, such as supervised learning, unsupervised learning, and reinforcement learning. Generative AI models 140 can utilize data set from data 132 to create logical inferences between various complex structures in the data set to generate coherent outputs for prompts input into the models 140.

The generative AI models 140 can include any machine learning (ML) or artificial intelligence (AI) model designed to generate content or new content, such as text, images, or code, by learning patterns and structures from existing data. The generative AI model 140 can be any model, a computational system or an algorithm that can learn patterns from data (e.g., chunks of data from various input documents, computer code, templates, forms, etc.) and make predictions or perform tasks without being explicitly programmed to perform such tasks. The generative AI model 140 can refer to or include a large language model. The generative AI model 140 can be trained using a dataset of documents (e.g., text, images, videos, audio or other data). The generative AI model 140 can be designed to understand and extract relevant information from the dataset. The generative AI model 140 can leverage natural language processing techniques and pattern recognition to comprehend the context and intent of the prompt (e.g., instruction 160), which can be used as input into the ML model 140.

The generative AI model 140 can be built using deep learning techniques, such as neural networks, and can be trained on large amounts of data. The generative AI model 140 can be designed, constructed or include a transformer architecture with one or more of a self-attention mechanism (e.g., allowing the model to weigh the importance of different words or tokens in a sentence when encoding a word at a particular position), positional encoding, encoder and decoder (multiple layers containing multi-head self-attention mechanisms and feedforward neural networks). For example, each layer in the encoder and decoder can include a fully connected feed-forward network, applied independently to each position. The data processing system 110 can apply layer normalization to the output of the attention and feed-forward sub-layers to stabilize and improve the speed with which the generative AI model 140 is trained. The data processing system 110 can leverage any residual connections to facilitate preserving gradients during backpropagation, thereby aiding in the training of the deep networks. Transformer architecture can include, for example, a generative pre-trained transformer, a bidirectional encoder representations from transformers, transformer-XL (e.g., using recurrence to capture longer-term dependencies beyond a fixed-length context window), text-to-text transfer transformer,

The generative AI model 140 can be trained (e.g., by a model training function) using any text-based dataset by converting the text data from the input dataset documents into numerical representations (e.g., embeddings) of the chunks of those documents. These embeddings can capture the semantic meaning of words, paragraphs, pages or sentences, depending on the size and type of chunks of dataset documents are parsed into. Embeddings can be used to represent and organize the dataset documents within a high-dimensional space (e.g., embedding space), where similar documents or concepts are located closer together. Embedding space can include a multi-dimensional vector space where each data point is represented by an embedding.

ML model trainer 142 can train the one or more ML models 140 using labeled datasets comprising one or more function sequences 114 performing the plurality of actions in a correct order and one or more function sequences 114 performing the plurality of actions in an incorrect order. The ML models 140, following the training, can be utilized by function sequence manager 112 or sequence validator 150 to identify one or more patterns for the plurality of function sequences 114. The ML models 140 can be configured or trained to classify, based on the one or more patterns, the one or more function sequences 114 to select the sequence of functions to use for implementing operations 164.

Through training, the generative AI model 140 can learn, or adjust its understanding of mapping the embeddings to particular issues (e.g., prompts related to resource availability or constraints concerning the resources), by adjusting its internal parameters. Internal parameters can include numerical values of the generative AI model 140 that the model learns and adjusts during training to optimize its performance and make more accurate predictions. Such training and can include iteratively presenting the various data chunks or documents of the dataset (e.g., or their chunks, embeddings) to the generative AI model 140, comparing its predictions with the known correct answers, and updating the model's parameters to minimize the prediction errors. By learning from the embeddings of the dataset data chunks, the generative AI model 140 can gain the ability to generalize its knowledge and make accurate predictions or provide relevant insights when presented with prompts.

The generative AI model 140 can include any ML or AI model or a system that can learn from a dataset to generate new content (e.g., text or images) that resembles a distribution of the training dataset. A distribution of a dataset can include an underlying probability distribution representing the patterns and characteristics of the data used to train a generative AI model 140. For example, a training data distribution can represent statistical properties of a text data (e.g., text corpus), such as the frequency of words, the co-occurrence of terms, and the overall structure of the language used in the training dataset. The generative AI model 140 can include the functionality to utilize such a probability distribution of patterns and characteristics to generate new responses (e.g., predictions) that were not present in the dataset.

The data processing system 110 includes a model trainer 142 designed, constructed, and operational to train, identify, or operate the ML models 140. The model trainer 142 can train the ML models 140 based on any data 132, including performance data 134, training datasets 138, and various likelihoods 154, tolerances 156 and thresholds 158. The ML model trainer 142 can include tools and algorithms used to develop and refine ML models 140 for any functionality or determinations of functions sequence manager 112, sequence validator 150 or transactions processor 162. The ML model trainer 142 can facilitate processes such as adjusting model parameters and evaluating performance against validation datasets. For instance, ML model trainer 142 can employ techniques like cross-validation to ensure model robustness before deployment.

Training dataset 138 can include collections of data used to train machine learning models within the data processing system. Training dataset 138 can consist of historical examples that help models learn patterns and improve their predictive capabilities. For instance, training dataset 138 might contain past transaction records used to train an ml model for fraud detection. Training dataset 138 can include performance data 134 related to execution of a plurality of actions 116 using sequences of functions (e.g., function sequences 114) and according to a plurality of constraints 118 for the plurality of actions 116.

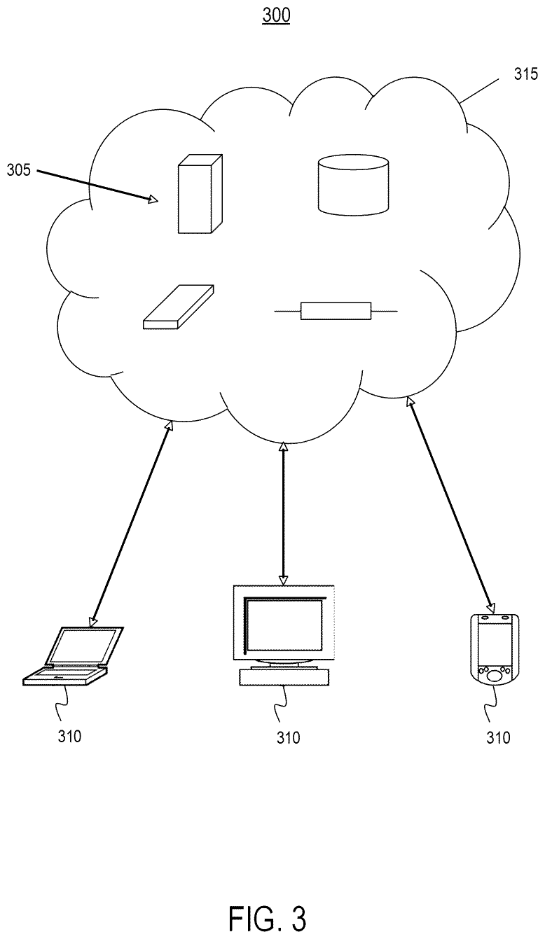

As shown in FIG. 2, computing system 200 includes a computing device 205. The computing device 205 can be resident on a network infrastructure such as within a cloud environment, as shown in FIG. 3, or can be a separate independent computing device (e.g., a computing device of a third-party service provider). The computing device 205 can include a bus 210, a processor 215, a storage device 220, a system memory (hardware device) 225, one or more input devices 230, one or more output devices 235, and a communication interface 240. One or more component of the computing system 200 can be part of or form the data processing system 110 displayed in example system 100 of FIG. 1.

The bus 210 permits communication among the components of computing device 205. For example, bus 210 can be any of several types of bus structures including a memory bus or memory controller, a peripheral bus, and a local bus using any of a variety of bus architectures to provide one or more wired or wireless communication links or paths for transferring data and/or power to, from, or between various other components of computing device 205.

The processor 215 can be one or more processors or microprocessors that include any processing circuitry operative to interpret and execute computer readable program instructions, such as program instructions for controlling the operation and performance of one or more of the various other components of computing device 205. In embodiments, processor 215 interprets and executes the processes, steps, functions, and/or operations of the technical solutions described herein, which can be operatively implemented by the computer readable program instructions.

For example, processor 215 provides an enterprise-wide security approach with all stakeholders (e.g., Dev teams, leadership, CSO office, etc.) with a set of various anomaly detection and transaction (e.g., payroll processing) integrity functionalities into single tool. In embodiments, the processor 215 uniformly integrates or packages existing functions for anomaly detection (e.g., using AI or other features) into a transaction integrity tool that standardizes and visually displays the output over different development teams for any purposes of anomaly detection or transaction integrity. The integrated security tool can capture specific requirements of the different teams, i.e., ensures that the tools support varied team development methodologies and different tech stacks to capture required security vulnerabilities. The processor 215 also establishes a regular feedback mechanism and can be used to develop a process for remediation timelines and priority including at risk vulnerabilities.

In embodiments, processor 215 can receive input signals from one or more input devices 230 and/or drive output signals through one or more output devices 235. The input devices 230 can be, for example, a keyboard, touch sensitive user interface (UI), etc., as is known to those of skill in the art such that no further description is required for a complete understanding of the technical solutions described herein. The output devices 235 can be, for example, any display device, printer, etc., as is known to those of skill in the art such that no further description is required for a complete understanding of the technical solutions described herein.

The storage device 220 can include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 205 in accordance with the different aspects of the technical solutions described herein. In embodiments, storage device 220 can store operating system 245, application programs 250, and program data 255 in accordance with aspects of the technical solutions described herein.

The system memory 225 can include one or more storage mediums, including for example, non-transitory media such as flash memory, permanent memory such as read-only memory (“ROM”), semi-permanent memory such as random-access memory (“RAM”), any other suitable type of storage component, or any combination thereof. In some embodiments, an input/output system 220 (BIOS) including the basic routines that help to transfer information between the various other components of computing device 205, such as during start-up, can be stored in the ROM. Additionally, data and/or program modules 225, such as at least a portion of operating system 245, application programs 250, and/or program data 255, that are accessible to and/or presently being operated on by processor 215 can be contained in the RAM.

The communication interface 240 can include any transceiver-like mechanism (e.g., a network interface, a network adapter, a modem, or combinations thereof) that enables computing device 205 to communicate with remote devices or systems, such as a mobile device or other computing devices such as, for example, a server in a networked environment, e.g., cloud environment. For example, computing device 205 can be connected to remote devices or systems via one or more local area networks (LAN) and/or one or more wide area networks (WAN) using communication interface 240.

As discussed herein, computing system 200 can be configured to integrate different anomaly detection and transaction integrity features into a single workbench or tool. This allows developers and other team members a uniform approach to assessing security vulnerabilities throughout the enterprise. In particular, computing device 205 can perform tasks (e.g., process, steps, methods and/or functionality) in response to processor 215 executing program instructions contained in a computer readable medium, such as system memory 225. The program instructions can be read into system memory 225 from another computer readable medium, such as data storage device 220, or from another device via the communication interface 240 or server within or outside of a cloud environment. In embodiments, an operator can interact with computing device 205 via the one or more input devices 230 and/or the one or more output devices 235 to facilitate performance of the tasks and/or realize the end results of such tasks in accordance with aspects of the technical solutions described herein. In additional or alternative embodiments, hardwired circuitry can be used in place of or in combination with the program instructions to implement the tasks, e.g., steps, methods and/or functionality, consistent with the different aspects of the technical solutions described herein. Thus, the steps, methods and/or functionality described herein can be implemented in any combination of hardware circuitry and software.

FIG. 3 shows an exemplary cloud computing environment 300 in accordance with aspects of the technical solutions described herein. In embodiments, one or more aspects, functions and/or processes described herein, including any features of the data processing system 110, can be performed and/or provided via cloud computing environment 300. As depicted in FIG. 3, cloud computing environment 300 includes cloud resources 305 that are made available to client devices 310 via a network 315, such as the Internet. Cloud resources 305 can be deployed or provided on a single network or a distributed network. Cloud resources 305 can be distributed across multiple cloud computing systems and/or individual network enabled computing devices. Cloud resources 305 can include a variety of hardware and/or software computing resources, such as servers, databases, storage, networks, applications, and platforms that perform the functions provided herein including storing code, anomaly detection and transaction integrity features or functionalities into a uniform and standardized application, e.g., display.

Client devices 310 can comprise any suitable type of network-enabled computing device, such as servers, desktop computers, laptop computers, handheld computers (e.g., smartphones, tablet computers), set top boxes, and network-enabled hard drives. Cloud resources 305 are typically provided and maintained by a service provider so that a client does not need to maintain resources on a local client device 310. In embodiments, cloud resources 305 can include one or more computing system 200 of FIG. 2 that is specifically adapted to perform one or more of the functions and/or processes described herein.

Cloud computing environment 300 can be configured such that cloud resources 305 provide computing resources to client devices 310 through a variety of service models, such as Software as a Service (SaaS), Platforms as a service (PaaS), Infrastructure as a Service (IaaS), and/or any other cloud service models. Cloud resources 305 can be configured, in some cases, to provide multiple service models to a client device 310 or computing systems 200, as shown in FIG. 2. For example, cloud resources 305 can provide both SaaS and IaaS to a client device 310. Cloud resources 305 can be configured, in some cases, to provide different service models to different client devices 310. For example, cloud resources 305 can provide SaaS to a first client device 310 and PaaS to a second client device 310.

Cloud computing environment 300 can be configured such that cloud resources 305 provide computing resources to client devices 310 through a variety of deployment models, such as public, private, community, hybrid, and/or any other cloud deployment model. Cloud resources 305 can be configured, in some cases, to support multiple deployment models. For example, cloud resources 305 can provide one set of computing resources through a public deployment model and another set of computing resources through a private deployment model.

In embodiments, software and/or hardware that performs one or more of the aspects, functions and/or processes described herein can be accessed and/or utilized by a client (e.g., an enterprise or an end user) as one or more of a SaaS, PaaS and IaaS model in one or more of a private, community, public, and hybrid cloud. Moreover, although aspects of the technical solutions described herein include a description of cloud computing, the systems and methods described herein are not limited to cloud computing and instead can be implemented on any suitable computing environment.

Cloud resources 305 can be configured to provide a variety of functionality that involves user interaction. Accordingly, a user interface (UI) can be provided for communicating with cloud resources 305 and/or performing tasks associated with cloud resources 305. The UI can be accessed via a client device 310 in communication with cloud resources 305. The UI can be configured to operate in a variety of client modes, including a fat client mode, a thin client mode, or a hybrid client mode, depending on the storage and processing capabilities of cloud resources 305 and/or client device 310. Therefore, a UI can be implemented as a standalone application operating at the client device in some embodiments. In other embodiments, a web browser-based portal can be used to provide the UI. Any other configuration to access cloud resources 305 can also be used in various implementations.

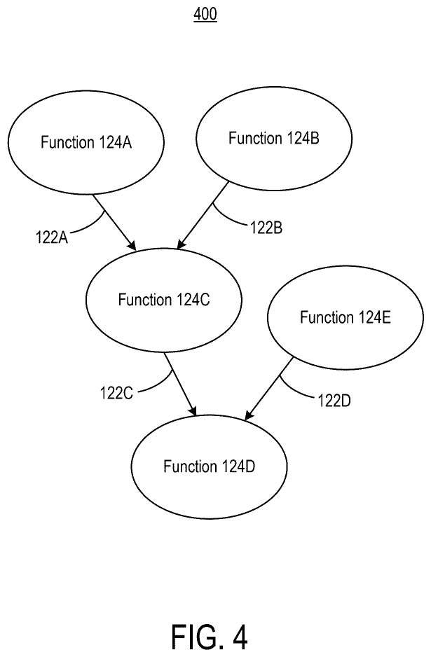

Referring now generally to FIGS. 4-8, examples of functions 124 and their respective relationships 122 to form function sequences 114 can be presented in the forms of various diagrams, matrices and tables. When introducing ML models 140, such as LLMs into a system, such as a data processing system 110, it can be relevant to understand the limitations of the operations of such LLMs to keep track of the system's operation and reliability. An important development in the use of LLMs, is the ability to use external tools to achieve improved outputs. For example, during run time an LLM can make function calls to an on-line store application programming interface (API) and retrieve information about available products. Monitoring of the function calls can be used to verify that the ML model 140 operation maintains its reliability while also sustaining its desired performance and providing the user satisfaction. To that end, the technical solutions described herein can monitor the function calls made by the data processing system 110 (e.g., transactions processor 162) and take measures to maintain the stability of the ML model 140 performance. The technical solutions can monitor the ML model's performance using, for example, Multiple Sequence Alignment (MSA) profiles to monitor the function calls and detect any anomalies in the model's behavior.

The ML model 140 (e.g., the LLM) can perform various operations 164 with different levels of variability in terms of their capacity to follow various process steps (e.g., various sequences). This variability raises the issue of the robustness of the ML model 140 when using complex web of function calls. Detecting anomalies in this process can facilitate taking measures to improve the ML model's performance to maintain the model's stability and performance.

For constructing a more robust solution with LLMs, the technical solutions can take on a “descriptive” and “prescriptive” view to model behavior. While with the first view, the technical solutions can target the characterization of the model behavior in a passive manner, with the second view, the solutions can actively use the uncovered descriptive insights to trigger desirable model behaviors. Adopting these as coupled views, and by iterating on them, the technical solutions can improve visibility on model weaknesses and hallucinations or drifts.

The technical solutions can begin by defining an approach to describe what the ML model 140 is doing. For example, a model (e.g., ML model 140) can be referred to as Φ(p) and it can be capable of using, at run time, a number of Python functions 124 (e.g., τ∈T), where T can be the set of available tools and the parameter p can refer to a collection of model configurations, including a prompt to be input into the ML model 140. In coming up with an output, the model can produce, at run

$${r}_{i} ∈ {\{ {r}_{i} \}}_{i = 1}^{R} ,$$

a sequence of function calls

$${S}^{( r )} = {\{ {s}_{i}^{( r )} \}}_{i = 1}^{{N}^{( r )}} ,$$

where

$${s}_{i}^{( r )}$$

can be the i-th function call made by the ML model and sᵢ∈T.

For instance, the technical solutions can assume that an acceptable answer is produced by the model if it produces a given S^{(r)} which can imply Tis expressive enough for a solution if one exists. In a sense, the sequence S can be a representation of the model's behavior and can be used for monitoring purposes. To facilitate such monitoring, for each τ∈T, the solutions can define a map M:T→A, which can map each available tool (e.g., function 124 to be called) to a unique symbol from an alphabet A (e.g., functions 124A, 124B, 124 C and so on). For instance, the solution can introduce a map M to translate S^{(r)} into expression

$${S}^{{( r )}^{′}} = {\{ {s}_{i}^{{( r )}^{′}} \}}_{i = 1}^{{N}^{( r )}} ,$$

where

$${s}_{i}^{{( r )}^{′}} = M ( {s}_{i}^{( r )} ) .$$

Additionally, the solution can assume or determine that |S^{(r)}|=|S^{(r)}′|.

While large value changes in p can be reflected in the output, the sequence S′ can often be stochastic in nature. For example, the model's behavior can be influenced by the model's sampling process, which can be the process used to produce a model completion, which is stochastic in nature. Second, the inherent complexity of the problem domain addressable by Φ via T and guided by p, can impose higher-order requirements for interpreting the process, leading to a stochastic output. The sequence S may not always the same for multiple runs of the same model configuration, also with the addition of sⱼ∉T.

Focusing on S′, the technical solutions can utilize Multiple Sequence Alignment (MSA). By constructing a profile of S′ for a given Φ(p) the solutions can describe the model behavior to a point where comparison across multiple p configurations can occur. A profile can represent a fundamental sequence the model is able to produce and act as a template for the model behavior. By using the MSA profiles, the technical solutions can pinpoint the ballpark of acceptable behavior within a family of model configuration p∈P as well as to detect anomalies in the operation of the model.

FIG. 4 illustrates an example diagram 400 of one or more function sequences 114 that can be provided via a directed graph 120, such as a directed acyclic graph (DAG). The directed graph 120 can represent a group of functions 124A-124E whose relationships 122A-122D indicate the order of the functions 124A-124E to be executed. In the example diagram 400, directed graph 120 (e.g., a DAG) can show a function 124A to be indicated by relationship 122A that precedes a function 124C, which is also preceded by a function 124B, as indicated by relationship 122B. A function 124E can be indicated by relationship 122D to precede a function 124D, which is also preceded by function 124C, as indicated by relationship 122C. Accordingly, diagram 400 provides a DAG in which functions 124A and 124B are to be executed before the execution of function 124C and functions 124C and 124E are to be executed before the execution of function 124D. Accordingly, the set of functions 124A-E can be a part of a DAG, where each node represents a function and each edge represents a dependency between functions as shown in diagram 400.

For instance, an ML model 140 (e.g., the model Φ(p)) can be configured to call a function if all its dependencies have been called. In this case, the set of tools T is the set comprised by the nodes in the DAG. the sequence S′ can be represented as a path in the DAG. In some examples, all of nodes are to be included in S′ and that a path is not a continued one from node X to node Y when multiple roots exist. Using the DAG the technical solutions can sample the model behavior (assuming the set A is the set of nodes in the DAG). The full samples can be provided in a table form in which symbol A corresponds to 124A, B corresponds to 124B, C corresponds to 124C, D corresponds to 124D and E corresponds to 124E in relation to functions 124A-124E of FIG. 4, as illustrated, for example, in Table 1 below:

TABLE 1
Matrix representation the unique sequences
in the diagram 400 of FIG. 4.

| S^{(r)′} | ${s}_{0}^{{( r )}^{′}}$ | ${s}_{1}^{{( r )}^{′}}$ | ${s}_{2}^{{( r )}^{′}}$ | ${s}_{3}^{{( r )}^{′}}$ | ${s}_{4}^{{( r )}^{′}}$ |
|---|---|---|---|---|---|
| S^{(0)′} | B | A | C | E | D |
| S^{(1)′} | B | A | E | C | D |
| S^{(2)′} | E | A | B | C | D |
| S^{(3)′} | E | B | A | C | D |
| S^{(4)′} | B | E | A | C | D |
| S^{(5)′} | A | B | C | E | D |
| S^{(6)′} | A | B | E | C | D |
| S^{(7)′} | A | E | B | C | D |

Only 8 sequences are topologically possible for this example. The sequence alphabet in this case is A={A, B, C, D, E}.

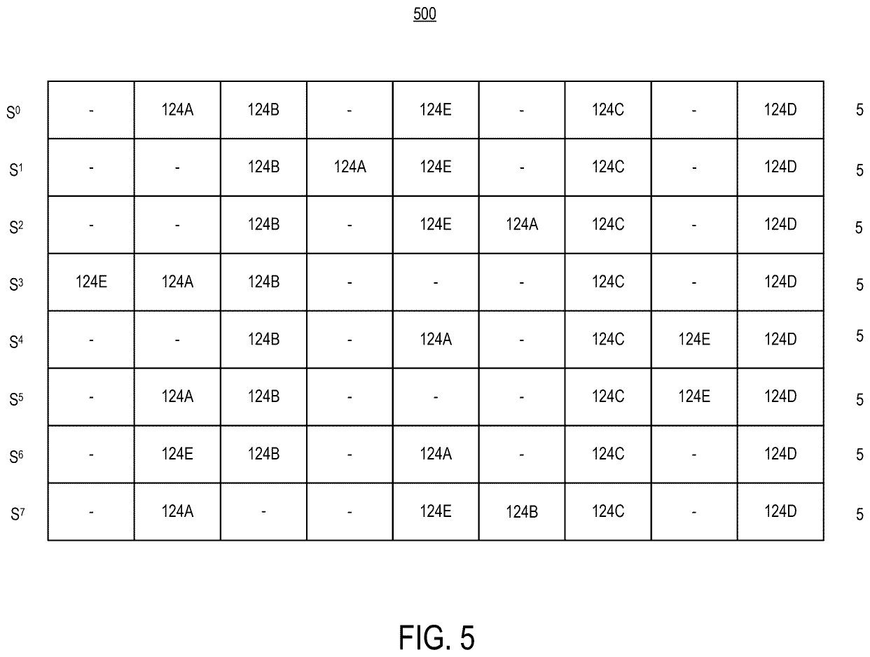

FIG. 5 illustrates an example profile 500 implemented using multiple sequence alignment (MSA) of functions 124A-124E illustrated in the diagram 400 of FIG. 4. Each row in the table, indicated as S0 through S7 (e.g., total of 8 sequences) refers to a sequence of functions 124A-124E. The count of 5 at the end of each row corresponds to the count of symbols (e.g., functions) implemented in each sequence.

As shown in example profile 500 can align the sequences using an MSA. The MSA can be a generalization of pairwise sequence alignment, where multiple sequences can be aligned simultaneously. The MSA can be used for detecting conserved regions in sequences, which can be used to infer the function of unknown sequences. The technical solutions can use Center Star using Needleman-Wunch dynamic programming algorithm.

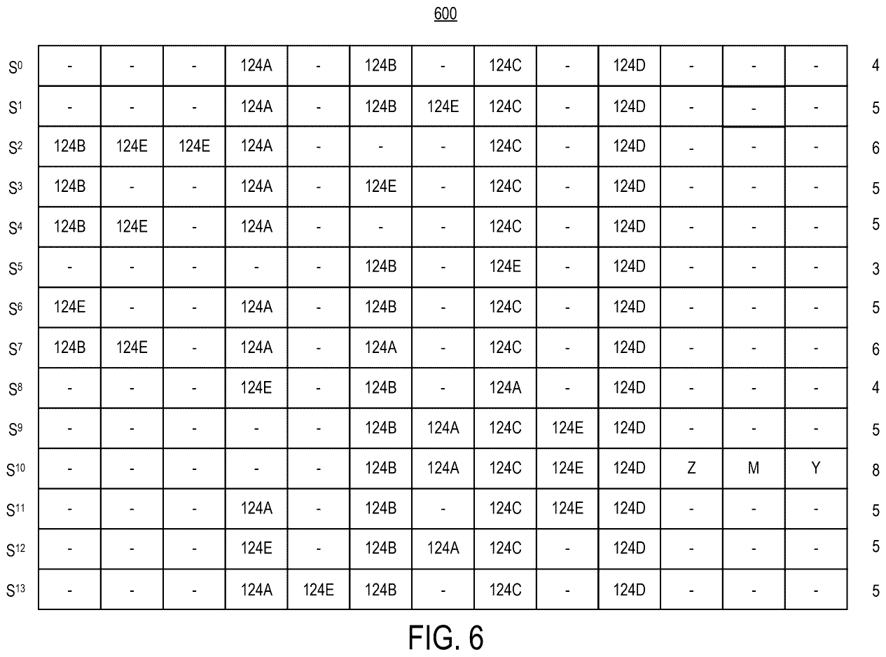

FIG. 6 illustrates an example 600 of multiple sequence alignment (MSA) with mutations (e.g., drifts or hallucinations) in the process. Using for example, the same example as in FIGS. 4 and 5, mutations can be introduced to show variations in the process operations. Introduced variations can include repetitions of the functions 124, deletions of the functions 124 or insertion of the functions 124 that are not intended to be used. As such, some of the entries in example 600 of the MSA can have missing functions 124, included dual copies of functions 124 or disordered functions.

Example 600 can include the MSA of the sequences with mutations having conserved regions represented as the MSA aligned columns. These can be columns that are conserved across all sequences. The conserved regions can be relevant as they can be used to form expectations around sequences the model produces for a given p. From this, the solutions can be capable of measuring the likelihood of undesirable sequence be generated by the model (e.g., by the model of the MSA acting as proxy for the actual model Φ(p)).

In the context of MSA, profiles, such as those expressed in example 600, can be computed aiming at describing the universe of possibilities for each sequence. A profile can indicate or model the probability of a symbol a∈A to appear in a given position i. A profile model can include or utilize a Hidden Markov Model (HMM) or a Profile Hidden Markov Model (PHMM). The HMM can be a generative model that assumes the existence of a hidden state sequence expressed as:

$$Q = {\{ {q}_{i} \}}_{i = 1}^{ℒ} ,$$

which can generate the observation sequence which can be expressed as:

$${S}^{{( r )}^{′}} = {\{ {s}_{i}^{{( r )}^{′}} \}}_{i = 1}^{{N}^{( r )}} .$$

Compared with regular HMM, PHMMs can define, for each position in the sequence, three types of states: match states, insert states and delete states. Therefore, the PHMM can be visualized as a series of columns, where each column represents a position in the sequence (see FIG. 4). Any arbitrary sequence can then be represented as a traversal of states from column to column.

Match states can form the core of the model. Each match state can be represented by a set of emission probabilities for each symbol in the output alphabet. These probabilities can indicate the distribution of values for a given position in a sequence. Each match state can probabilistically transition to the next (i.e. next-column) match and delete states as well as the current (i.e. current-column) insert state.

Insert states can represent possible values that can be inserted at a given position in a sequence (e.g., before a match emission or deletion). They can be represented in the same manner as match states, with each output symbol having an associated probability. Insert states can be used to account for symbols that have been inserted to a given position that might not otherwise have occurred “naturally” via a match state. Insert states can probabilistically transition to the next match and delete states as well as the current insert state (i.e. itself). Allowing insert states to transition to themselves enables the consideration of multiple-symbol inserts.

Similarly, delete states can represent symbols that have been removed from a given position. For a sequence to use a delete state for a given position can indicate that a given character position in the model has no corresponding characters in the given sequence. Hence, delete states can be silent and thus have no emission probabilities for the output symbols. This can be a distinction from match states and insert states. Each delete state can probabilistically transition to the next match and delete states as well as the current insert state.

Example 600 of FIG. 6 can include match states in the columns 4, 6, 8, 10 (also known as conserved regions). The other columns can be referred to as insert states. A sequence can have a symbol in a match column, it is a match state emission. When there is instead a gap, denoted by the symbol “-”, this can be a delete state occurrence. Any characters in insert columns can be insert state emissions, and gaps in insert columns can represent that the particular insert state was not used for a sequence in question.

When training an PHMM, a topology of the model can be determined and it may not be the same for every model Φ(p), but it can vary based on the alignment produced. This variation can be a property of the presence of insertion and deletion states, which can be a property of Φ(p) and dependent on the MSA outcome.

Heuristics can be used to define the topology of the model. A heuristic can be used to label the columns that match states for which half or more of the sequences have a symbol present (rather than a gap). Other columns can be labelled insert states. Then the probability aᵢⱼ of state i transitioning to state j can be estimated by counting the number of times Aᵢⱼ that the transition is used in the alignment, using the following expression:

$${a}_{ij} = \frac{{A}_{ij}}{{\sum }_{k} {A}_{ik}}$$

Similarly, the probability ei (ϵ) of state i emitting symbol e is estimated by counting the number of times Ek (ϵ) that the emission is used in the alignment, as expressed in the expression:

$${e}_{i} ( ϵ ) = \frac{{E}_{i} ( ϵ )}{{\sum }_{{ϵ}^{′}} {E}_{i} ( {ϵ}^{′} )}$$

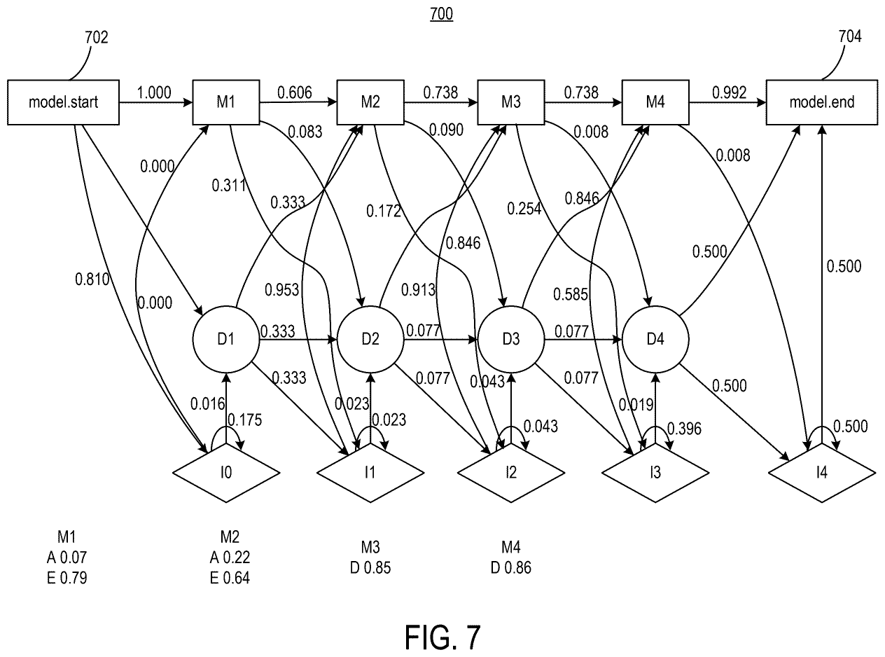

FIG. 7 illustrates an example diagram 700 of a profile hidden Markov model (PHMM). The example diagram 700 can include model start 702 and a model end 704 and four iterations between the two, each of which can be represented as a node. Between the nodes, which can correspond to various functions being executed along the way, there are arrows that can represent relationships 122 using values between 0 and 1. In the illustrated example, the model start 702 can begin at 1.00 likelihood (e.g., certainty) and the sequence or order of functions can lead to relationships such as 0.606 between the first (e.g., M1) and second (e.g., M2) model determination, 0.738 value between M2 and M3, 0.738 between M3 and M4 and 0.992 between M4 and model end 704. This chain or order can correspond to sequence function that can be selected by the data processing system 110 to be implemented.

When a PHMM is to be constructed from a set of unaligned sequences, an initial alignment can be generated after which training can happen via the Baum-Welch algorithm. The number of match states can define the length of the PHMM. One can set the average length of the unaligned sequences as the length of the model. To generate the initial model, which can amount to setting the transition and emission probabilities to some initial values, the probabilities can be sampled from Dirichlet distributions. Once a PHMM is constructed, it can be used to evaluate a given sequence for membership in the estimated model behavior. This can be done via a straightforward application of the forward algorithm (to get the full probability of the given sequence) or the Viterbi algorithm (to get the alignment of the sequence to the family of sequences).

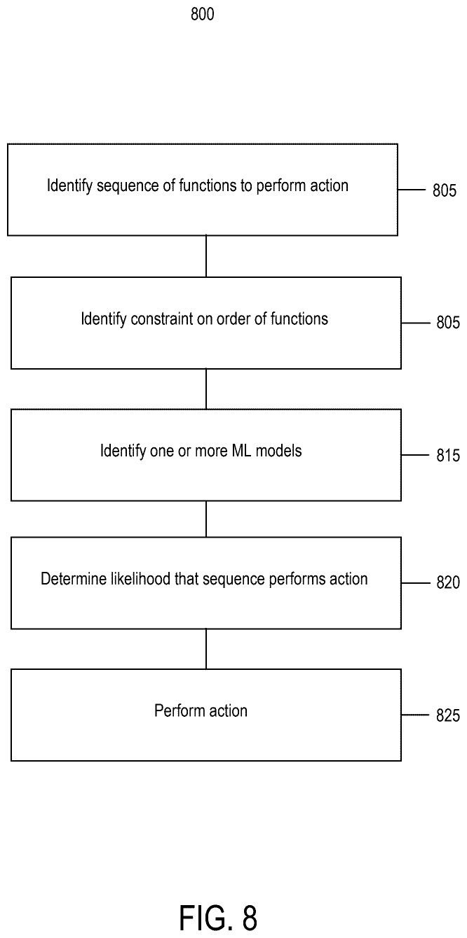

FIG. 8 depicts a method 800 for machine learning based validation of processing operations using probabilistic sequence alignment. The method 800 can be performed using one or more systems, features, acts or components depicted or discussed in connection with FIGS. 1-7. For instance, method 800 can be implemented, for example, using a data processing system 110 of FIG. 1 implemented on a computing system 200 of FIG. 2 or on a cloud computing environment 300 of FIG. 3. For instance, the method 800 can be implemented by one or more processors 215 executing operations based on instructions and data stored in a system memory 225, where the instructions can cause the one or more processors 215 to implement any functionality of the data processing system 110 and its components. The method 800 can include any acts be implemented in any order sequence or combination with potentially additional acts, some of which can overlap in time, and one or more of which can be omitted in various contemplated implementations. The method 800 can include acts or operations 805-825. At 805, the method can include identifying a sequence of functions to perform an action. At 810, the method can identify one or more constraints on order of functions. At 815, the method can identify one or more ML models. At 820, the method can determine likelihood that the sequence of functions perform the action. At 825, the method can perform the action. In some examples, the system can provide an instruction to perform the action.

At 805, the method can include identifying a sequence of functions to perform an action. The method can include one or more processors coupled with memory identifying, from a plurality of sequences, a sequence of functions to perform an action on a transaction processing system. For example, a functions sequence manager of a data processing system can generate (e.g., using one or more models) a plurality of function sequences representing a plurality of operations or actions to be taken. From the plurality of sequences, the functions sequence manager can identify a function sequence whose relationships or likelihoods between the individual functions (e.g., actions to be performed to complete the action) exceeds a threshold (e.g., a maximum likelihood value or a likelihood value that is greater than a predetermined threshold).

The method can include the one or more processors receiving a request to perform the action. The method can include the one or more processors identifying, responsive to the request, the functions to perform the action. For instance, a function sequence manager can utilize a multiple sequence alignment (MSA) identifying a plurality of possible function sequences in rows and columns of a table. The one or more processors can identify the plurality of sequences of the functions, where each sequence of the plurality of sequences can include an order or sequence of function in which to execute the functions that is different from an order in which to execute the functions of each other sequence of the plurality of sequences. For instance, a table (e.g., MSA representation) can represent or identify the plurality of function sequences having different relationships (e.g., likelihoods) of the functions of the sequences being completed in their respective orders or sequence in order to implement the action.

At 810, the method can identify one or more constraints on order of functions. The method can include the one or more processors identifying, for the action, a constraint on an order of functions within the sequence of functions. The order of functions can include an arrangement of precedence or a chronological order in which the functions within the sequence of functions are to be executed or implemented. The function sequence manager can identify, based on an action to be implemented (e.g., a payroll or HR operation), one or more constraints limiting the order of the functions to be performed to implement the given action. For instance, the constraint can include one or more functions that are to be included in the function sequence. The method can include function sequence generator generating the plurality of sequences, using, for example, a Profile Hidden Markov Model (PHMM) that can be configured to evaluate a plurality of likelihoods for the plurality of sequences according to the constraint. For instance, the constraint can include one or more functions that are not to be included in the function sequence. For example, the constraint can include one or more functions that are to precede or follow a specific action. The constraints can include listing of particular functions to implement and one or more rules barring implementation of one or more functions before the completion of another one or more functions.

The method can include selecting, from the plurality of sequences, a selection of sequences comprising the sequence to choose for implementation of the function. Each sequence of the selection of sequences can satisfy one or more constraints on the respective order of functions within each sequence of the selection of sequences. The function sequence to be selected for implementation of the function can have relationships or likelihoods of successful completion between individual functions that exceeds all other function sequences (e.g., the maximum likelihood value). For instance, the method can include the sequence validator identifying, from the selection of sequences, the sequence according to the constraint and performance data of the sequence. The performance data can include likelihood values between each of the individual functions in a function sequence. The likelihood values of the selected sequence can be larger than the likelihood values of other function sequences not selected, thereby indicating the highest likelihood of success for the selected sequence.

The constraint can correspond to one or more rules configured to define an order of execution of at least a subset of the functions. The order of execution can specify that a first function of the functions be executed before execution of a second function of the functions. The constraint can correspond to one or more rules configured to preclude execution of one or more functions during the execution of the functions used to perform the action. The method can include determining that one or more sequences of the plurality of sequences do not satisfy the constraint on the order of at least a subset of the functions and then filtering out, from the plurality of sequences, the one or more sequences based on the one or more sequences not satisfying the constraint.

At 815, the method can identify one or more ML models. The method can include the one or more processors identifying one or more machine learning (ML) models trained on performance data related to execution of a plurality of actions using sequences of functions and according to a plurality of constraints for the plurality of actions. The method can identify and use ML models trained to generate function sequences based on constraints and actions. The method can identify and use ML models trained to determine likelihoods of success of functions of a function sequence to achieve the desired result (e.g., implement action without error). The method can identify and user ML models to evaluate functions or function sequences based on tolerances and threshold. The ML models can be implemented based on prompts input into the models.

The one or more ML models can include a large language model (LLM) trained on performance data related to execution of actions. The actions can include to at least one of: operations related to payroll processing or operations related to human resources processing. The method can include training of the one or more ML models using labeled datasets that can include sequences of functions performing the plurality of actions in a correct order and sequences of functions performing the plurality of actions in an incorrect order. The method can include utilizing, following the training, the one or more ML models to identify one or more patterns for the plurality of sequences or determining the likelihoods of the function sequence to implement one or more actions without an error or failure. The method can include classifying, based on the one or more patterns and using one or more ML models, the one or more sequences to select the sequence of functions.

At 820, the method can determine likelihood that the sequence of functions perform the action. The method can include the one or more processors determining, using the one or more ML models, a likelihood that the sequence of functions performs the action within a performance tolerance and according to the constraint. For instance, the sequence validator can utilize one or more ML models to evaluate one or more likelihoods for one or more functions in the sequence of functions to be performed according to one or more tolerances and within one or more thresholds.

The method can include the sequence validator determining, for the plurality of sequences using a multiple sequence alignment (MSA), one or more relationships between the functions. The one or more relationships can define or identify an order in which at least a first function of the functions is to be executed before execution of a second function of the functions. The method can include generating, based on the one or more relationships, a plurality of profiles for the plurality of sequences. The profiles can list various sequences according to their list of functions and the order or sequence for those functions.

The method can include determining that the function sequence is performed within a performance tolerance. The performance tolerance can include a tolerance corresponding to an acceptable likelihood that the sequence of functions will be executed without an error or an interruption. The performance tolerance can include a tolerance corresponding to an acceptable variance in system performance metrics. The performance metrics can include at least one of: an execution time, an amount of resources used, a throughput of functions per unit of time or an error rate, the performance tolerance includes at least one of: a tolerance for a duration of time to perform the action, a tolerance for an amount of resources to use to perform the action, a tolerance for an allowable error rate while performing the action, a tolerance for a minimum throughput of functions to be executed within a specified period, or a tolerance for a latency between initiating performance of the action and completion of the performance of the action from the transaction processing system.

The method can utilize one or more ML models to determine the likelihood that the function sequence successfully (e.g., without failure or error) performs the function. The ML models can utilize a directed acyclic graph (DAG) to represent dependencies between the functions according to the constraint. The method can include determining, for each of the plurality of sequences, a risk score corresponding to a likelihood that the respective sequence of the plurality of sequences results in an error during the performance of the action. The method can include selecting, from the plurality of sequences, the sequence of functions based on the respective score of the sequence of actions.

At 825, the method can provide an action. The method can perform the action responsive to determining that the likelihood that the sequence successfully performs the action exceeds a threshold. For example, the action can include generating an instruction to perform the action. The method can include the one or more processors providing, responsive to the likelihood satisfying a threshold, an instruction to the transaction processing system to cause the transaction processing system to perform the action using the sequence of functions. The method can include the sequence validator generating an instruction identifying the selected function sequence to perform. The instruction can be issued or provided to a transactions processor to perform the operation and implement the action.

The method can include the one or more processors determining, responsive to the likelihood not satisfying the threshold, to not transmit the instruction to the transaction processing system. For instance, one or more function sequences can have their likelihoods of successful operation or execution of the function fall below a threshold value. In response to the function sequences not satisfying the threshold value for the likelihood of success, the sequence validator can determine not to issue the instruction for those function sequences. When multiple function sequences satisfy the threshold value, the sequence validator can issue the instruction for execution of the operation using the function sequence that has the higher likelihood of success than other remaining function sequences.

Although an example computing system has been described in FIG. 2, the subject matter including the operations described in this specification can be implemented in other types of digital electronic circuitry, or in computer software, firmware, or hardware, on the cloud-based systems or in any structures described in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

The subject matter and the operations described in this specification can be implemented in digital electronic circuitry, or in computer software, firmware, or hardware, including the structures described in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently described systems or methods, their components, acts, or elements to single or plural configurations. References to any act or element being based on any information, act or element may include implementations where the act or element is based at least in part on any information, act, or element.

Any implementation described herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations described herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the described elements and operations without departing from the scope of the technical solutions described herein.

References to “approximately,” “substantially”, or other terms of degree include variations of +/−10% from the given measurement, unit, or range unless explicitly indicated otherwise. Coupled elements can be electrically, mechanically, or physically coupled with one another directly or with intervening elements. Scope of the Systems and methods described herein is thus indicated by the appended claims, rather than the foregoing description, and changes that come within the meaning and range of equivalency of the claims are embraced therein.

What is claimed is:

1. A system, comprising:
one or more processors, coupled with memory, to:
identify, from a plurality of sequences, a sequence of functions to perform an action on a transaction processing system;
identify, for the action, a constraint on an order of functions within the sequence of functions;
identify one or more machine learning (ML) models trained on performance data related to execution of a plurality of actions using sequences of functions and according to a plurality of constraints for the plurality of actions;
determine, using the one or more ML models, a likelihood that the sequence of functions performs the action within a performance tolerance and according to the constraint; and
provide, responsive to the likelihood satisfying a threshold, an instruction to the transaction processing system to cause the transaction processing system to perform the action using the sequence of functions.

2. The system of claim 1, comprising the one or more processors to:
receive a request to perform the action;
identify, responsive to the request, the functions to perform the action;
identify the plurality of sequences of the functions, each sequence of the plurality of sequences comprising an order in which to execute the functions that is different from an order in which to execute the functions of each other sequence of the plurality of sequences.

3. The system of claim 1, comprising the one or more processors to:
select, from the plurality of sequences, a selection of sequences comprising the sequence, each sequence of the selection of sequences satisfying one or more constraints on the respective order of functions within each sequence of the selection of sequences;
identify, from the selection of sequences, the sequence according to the constraint and performance data of the sequence and using a Profile Hidden Markov Model (PHMM) configured to evaluate a plurality of likelihoods for the plurality of sequences according to the constraint.

4. The system of claim 1, wherein the one or more ML models includes a large language model (LLM) trained on performance data related to execution of actions corresponding to at least one of: operations related to payroll processing or operations related to human resources processing.

5. The system of claim 1, comprising the one or more processors to:
determine that one or more sequences of the plurality of sequences do not satisfy the constraint on the order of at least a subset of the functions; and
filter out, from the plurality of sequences, the one or more sequences based on the one or more sequences not satisfying the constraint.

6. The system of claim 1, wherein the constraint corresponds to one or more rules configured to define an order of execution of at least a subset of the functions, the order of execution specifying that a first function of the functions be executed before execution of a second function of the functions.

7. The system of claim 1, wherein the constraint corresponds to one or more rules configured to preclude execution of one or more functions during the execution of the functions used to perform the action.

8. The system of claim 1, comprising the one or more processors to:
determine, for the plurality of sequences using a multiple sequence alignment (MSA), one or more relationships between the functions, the one or more relationships defining an order in which at least a first function of the functions is to be executed before execution of a second function of the functions; and
generate, based on the one or more relationships, a plurality of profiles for the plurality of sequences.

9. The system of claim 1, wherein the performance tolerance includes a tolerance corresponding to an acceptable likelihood that the sequence of functions will be executed without an error or an interruption.

10. The system of claim 1, wherein the performance tolerance includes a tolerance corresponding to an acceptable variance in system performance metrics, the performance metrics including at least one of: an execution time, an amount of resources used, a throughput of functions per unit of time or an error rate.

11. The system of claim 1, wherein the performance tolerance includes at least one of: a tolerance for a duration of time to perform the action, a tolerance for an amount of resources to use to perform the action, a tolerance for an allowable error rate while performing the action, a tolerance for a minimum throughput of functions to be executed within a specified period, or a tolerance for a latency between initiating performance of the action and completion of the performance of the action from the transaction processing system.

12. The system of claim 1, further comprising the one or more processors configured to utilize a directed acyclic graph (DAG) to represent dependencies between the functions according to the constraint.

13. The system of claim 1, comprising the one or more processors to:
determine, for each of the plurality of sequences, a score corresponding to a likelihood that the respective sequence of the plurality of sequences results in an error during the performance of the action; and
select, from the plurality of sequences, the sequence of functions based on the respective score of the sequence of actions.

14. The system of claim 1, comprising the one or more processors to determine, responsive to the likelihood not satisfying the threshold, to not transmit the instruction to the transaction processing system.

15. The system of claim 1, comprising the one or more processors to:
train the one or more ML models using labeled datasets comprising sequences of functions performing the plurality of actions in a correct order and sequences of functions performing the plurality of actions in an incorrect order;
utilize, following the training, the one or more ML models to identify one or more patterns for the plurality of sequences; and
classify, based on the one or more patterns, the one or more sequences to select the sequence of functions.

16. A method, comprising:
identifying, by one or more processors coupled with memory, from a plurality of sequences, a sequence of functions to perform an action on a transaction processing system, the identification is based on a constraint on an order of functions within the sequence of functions;
identifying, by the one or more processors, one or more machine learning (ML) models trained on performance data related to execution of a plurality of actions using sequences of functions and according to a plurality of constraints for the plurality of actions;
determining, by the one or more processors, using the one or more ML models, a likelihood that the sequence of functions performs the action within a performance tolerance and according to the constraint;
providing, by the one or more processors, responsive to the likelihood satisfying a threshold, an instruction to the transaction processing system to cause the transaction processing system to perform the action using the sequence of functions.

17. The method of claim 16, comprising:
receiving, by the one or more processors, a request to perform the action;
identifying, by the one or more processors, responsive to the request, the functions to perform the action;
identifying, by the one or more processors, the plurality of sequences of the functions, each sequence of the plurality of sequences comprising an order in which to execute the functions that is different from an order in which to execute the functions of each other sequence of the plurality of sequences.

18. The method of claim 16, comprising:
selecting, by the one or more processors, from the plurality of sequences, a selection of sequences comprising the sequence, each sequence of the selection of sequences satisfying one or more constraints on the respective order of functions within each sequence of the selection of sequences;
identifying, by the one or more processors, from the selection of sequences, the sequence according to the constraint and performance data of the sequence.

19. The method of claim 16, comprising:
determining, by the one or more processors, that one or more sequences of the plurality of sequences do not satisfy the constraint on the order of at least a subset of the functions;
filtering out, by the one or more processors, from the plurality of sequences, the one or more sequences based on the one or more sequences not satisfying the constraint.

20. A non-transitory computer-readable media having processor readable instructions, such that, when executed, cause at least one processor to:
identify, from a plurality of sequences, a sequence of functions to perform an action on a transaction processing system;
identify, for the action, a constraint on an order of functions within the sequence of functions;
identify one or more machine learning (ML) models trained on performance data related to execution of a plurality of actions using sequences of functions;
determine, using the one or more ML models, a likelihood that the sequence of functions performs the action within a performance tolerance when executed according to the constraint on the order of functions;
provide, responsive to the likelihood satisfying a threshold, an instruction to the transaction processing system to cause the transaction processing system to perform the action using the sequence of functions.
